(19) United States
(12) Patent Application Publication
(10) Pub. No.: US 2020/0055080 A1
(43) Pub. Date: Feb. 20, 2020

(54) METHOD AND DEVICE FOR SPRAY PAINTING A WORKPIECE

(71) Applicant: EISENMANN SE, Böblingen (DE)

(72) Inventor: Marc Walter KIRCHNER, Bammental (DE)

(21) Appl. No.: 16/539,762

(22) Filed: Aug. 13, 2019

(30) Foreign Application Priority Data
Aug. 14, 2018 (EP) 18 188 849.6

(51) Int. Cl. B05D 1/32; B05B 16/20; B05D 1/02; B05B 12/22

(52) U.S. Cl. CPC B05D 1/32; B05B 12/22; B05D 1/02; B05B 16/20

(57) ABSTRACT

A method and a device for spray painting a workpiece uses an application device. The workpiece has at least two components that are movable relative to each other which are at least arranged region by region or meshing with each other such that, dependent on the relative position of the components, at least a subregion of one of components is mounted shaded so that the subregion is inaccessible for spray painting by the application device. The method and the device for the spray painting of workpieces, allow a fast, complete and cost-effective painting of a workpiece. One of the components is moved during the spray painting by means of an actuator such that the subregion of the component is displaced so that the subregion is not shaded and is accessible for spray painting by the application device.

### CROSS REFERENCE TO RELATED APPLICATIONS

This application claims the benefit of priority under 35 U.S.C. § 119 of European Application 18 188 849.6, filed Aug. 14, 2018, the entire contents of which are incorporated herein by reference.

### TECHNICAL FIELD

The present invention relates to a method and a device for spray painting a workpiece by means of an application device, wherein the workpiece has at least two components that are movable relative to each other which are at least sectionally arranged or meshing with each other such that, dependent on the relative position of the components, at least a subregion of one of the components is mounted shadedly (blocked) so that the subregion is inaccessible for spray painting by the application device.

### TECHNICAL BACKGROUND

The surface of workpieces is coated with a paint in spray painting. For this purpose, the paint, in particular a corrosion protection, is applied by means of an application device, which is configured, for example, as a high-speed rotation atomizer and is fastened to a multi-axis robot. For complex workpieces, which are assembled from several components, the individual components were often spray painted and then assembled to form the finished workpiece. However, in the automotive industry in particular, there has been a transition to first assemble the unpainted components and then to paint the already assembled workpieces.

However, for workpieces that have components that are movable relative to each other, it should be noted that some components or at least subregions thereof should not or may not be spray painted. Such subregions are masked prior to spray painting by being covered by suitable films or the like.

Furthermore, in particular in the case of workpieces made from components which are movable relative to each other, some subregions of components can be covered by other components in such a way that these subregions are not reached for spray painting by the application device. To completely paint such workpieces, the spray painting must be interrupted and the affected components must be displaced by hand until a complete painting of the workpiece by the application device is possible. However, the interruption of the spray painting and the displacement of the components requires time and must be performed regularly by trained persons who are dressed in appropriate protective clothing, which is associated with a corresponding time and cost.

### SUMMARY

An On this basis, the object of the present invention is to provide a method and device for spray painting of workpieces, which allows a fast, complete and cost-saving painting of a workpiece.

In the context of the method according to the invention, it is provided that one of the components is moved during the spray painting by means of an actuator in such a way that the shaded subregion of the component is displaced so that it is accessible for spray painting by the application device.

The device according to the invention has an actuator which allows a movement of the component during the spray painting, so that the shaded subregion of the component is displaceable so that it is accessible for spray painting by the application device.

By means of the device according to the invention and the method according to the invention, even complex workpieces made of several components can be spray painted completely in an automatic booth, which components have concealed or shaded subregion. Thus, a fast, complete and in this case cost-saving painting of complex workpieces made of moving components is possible.

In the context of the present invention, the affected components of the workpiece can be movable in any manner relative to each other. In particular, it is provided that the components are rotatable relative to each other and that at least one of the components is rotated by the actuator or is rotatable by the actuator.

Regardless of the specific movable mounting of the components, it is preferably provided that the actuator has a contact device by means of which a detachable connection to the rotatable or displaceable component of the workpiece is obtainable. In the case of a rotatable component, it is preferably provided that the rotatable component is rotated by at least 30°, 60°, 90°, 120° or 180°, so that all regions of the component are reachable by the application device for spray painting.

The present method preferably comprises the following method steps for the complete spray painting of a workpiece:
a) Partially spray painting of the workpiece using the application device,
b) interrupting the spray painting,
c) rotating or displacing the component having at least one shaded subregion, so that the rotated or displaced subregion is accessible for spray painting by the application device,
d) spray painting the previously shaded subregion.
If a single rotation or displacement of the component is still not sufficient to completely paint the workpiece, the process steps a) to d) are repeated until the workpiece is painted at all desired regions.

As an alternative to interrupting the spray painting, also a continuous spray painting of the workpiece using the application device is provided, for which purpose the component is simultaneously rotated or displaced for spray painting until the workpiece is completely spray painted.

It has already been pointed out that in using the present device and using the present method, it is possible to spray paint complex workpieces which are assembled from several components and which are connected to each another in a partially movable manner. Such a workpiece can in particular be a motor vehicle axle which comprises
an axle body and
at least one brake caliper and
a wheel suspension having a brake disk and a wheel mount having a plurality of wheel bolts and/or a plurality of wheel bolt receptacles,
   wherein the wheel suspension is rotatable relative to the axle body and the brake caliper and subregions of the suspension, in particular subregions of the wheel mount and/or the brake disk are shaded dependent on the angular position of the brake caliper. Such motor vehicle axles are usually retracted for spray painting in a paint shop by hanging free-pendulum on a suitable transport device. The transport already takes place in the direction of the longitudinal axis of the motor vehicle axle for reasons of space. In order to be able to spray paint the entire motor vehicle axle using a single application device, first the side of the motor vehicle axle first entering into the paint shop is spray painted using the (front) wheel suspension located thereon. Here, the wheel suspension is rotated, dependent on the model, by a constant angle in one direction, for example, to the left seen in the transport direction. However, the actuator engages in the opposite direction to the transport direction of the wheel suspension and rotates the wheel suspension to the right from the perspective of the actuator. After spray painting the previously shaded region, the movable component remains in this position and is not rotated back to the original starting position.

Subsequently, the painting of the immovable axle body is effected, which is unproblematic even with a single application device.

In the subsequent painting of the (rear) wheel suspension, the wheel suspension is to be rotated to the left by a constant angle in the transport direction analogous to the front. Since the actuator in this case engages in the transport direction, a rotation of the wheel suspension to the left also takes place from its view. The movements on the front and rear wheel suspension must therefore be executed mirror-inverted. To be able to execute this complex sequence of movements, it is preferably provided that a two-sided rotation of the components is possible by means of the actuator and that a rotation takes place without a predetermined preferred direction. Only in this way can the same application device or the same actuator be used for the different sides of a motor vehicle axle, a second application device thereby being unnecessary. The motor vehicle axles can therefore be completely spray painted in a paint shop using a single application device.

In order to be able to fully paint motor vehicle axles of the type described, the contact device of the actuator is preferably a finger or a hook, which engages behind a wheel bolt when rotating the wheel suspension or is insertable into a wheel bolt receptacle.

Alternatively, the contact device can be configured as a gripper by means of which components of the workpiece are grippable, so that the components are rotatable and/or displaceable. In the case of a motor vehicle axle, for example, the brake disk and/or the wheel mount can be gripped and rotated using the gripper.

Finally, the contact device of the actuator can be a contact surface which forms a frictional contact with the component for rotating or displacing the components. For this purpose, the contact surface can have an elastic material which forms a non-slip contact with the component.

In all embodiments of the actuator, the contact device can comprise exchangeable wear elements, which can be removed in the event of wear and replaced by new or unworn elements. In addition, the contact device can be formed to be adjustable.

The actuator can be arranged directly on the application device for performing the method in which an interruption of the spray painting takes place. In the simplest case, this is a finger or a hook, which is configured laterally on the housing of the application device. As a result, the costs of a further movement unit can be saved. However, the spray painting must be interrupted to move the component. Alternatively, for this purpose, the actuator can be arranged on a separate robot arm, so that a rotation and/or displacement of the component by means of the actuator is possible, while the application device simultaneously spray paints the workpiece.

Specific embodiments of the present invention are explained below and with reference to the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic representation of a motor vehicle axle in a paint shop;

FIG. 2a is a detail view of the wheel suspension in the spray painting with shaded regions;

FIG. 2b is a detail view of the wheel suspension in the spray painting with shaded regions;

FIG. 3a is a detail view of the wheel suspension when rotating the wheel mount;

FIG. 3b is a detail view of the wheel suspension when rotating the wheel mount;

FIG. 4a is a detail view of the wheel suspension when rotating the wheel mount;

FIG. 4b is a detail view of the wheel suspension when rotating the wheel mount; a

FIG. 5a is a schematic view of an alternative contact device of an actuator; and

FIG. 5b is a schematic view of an alternative contact device of an actuator.

### DESCRIPTION OF PREFERRED EMBODIMENTS

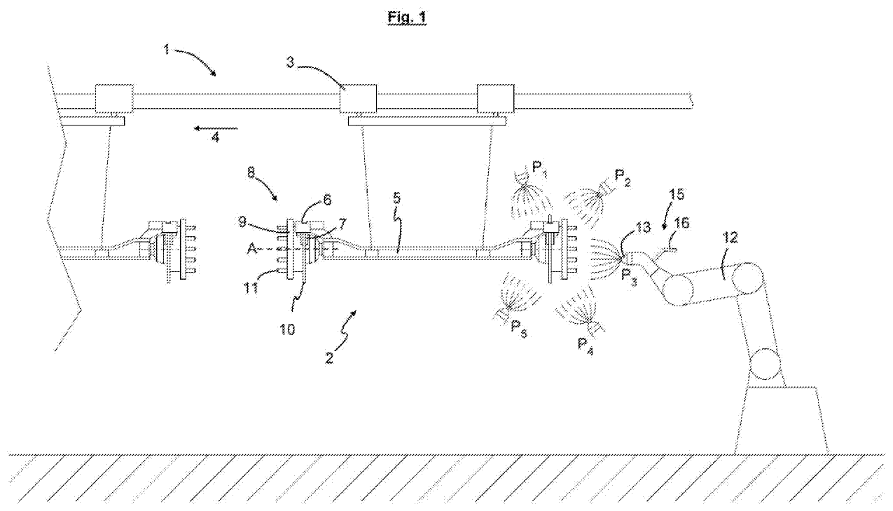

Referring to the drawings, FIG. 1 shows a paint shop 1 for spray painting motor vehicle axles 2. The motor vehicle axle 2 is suspended for this purpose on a transport device 3, which preferably continuously moves the motor vehicle axle 2 in transport direction 4, thus avoiding vibrations of the motor vehicle axle 2 when stopping and starting. The motor vehicle axle 2 has an axle body 5, on which are arranged on both sides respectively a brake caliper 6 having brake linings 7 and a wheel suspension 8 respectively having a wheel mount 9 and brake disks 10. The wheel mount 9 has a plurality of wheel bolts 11, which serve for later receiving of a wheel. Furthermore, the wheel 9 is rotatably mounted together with the brake disk 10 about the longitudinal axis A of the motor vehicle axle 2.

A robot arm 12 is provided for spray painting the motor vehicle axle 2, at the tip of which robot arm an application device 13 is attached in the form of a high-speed rotation atomizer. The application device 13 can be aligned in any position due to the elements of the robot arm 12 being arranged movable relative to each other. Five different positions P_{1, . . . , 5} of the application device 13 are illustrated by way of example in FIG. 1.

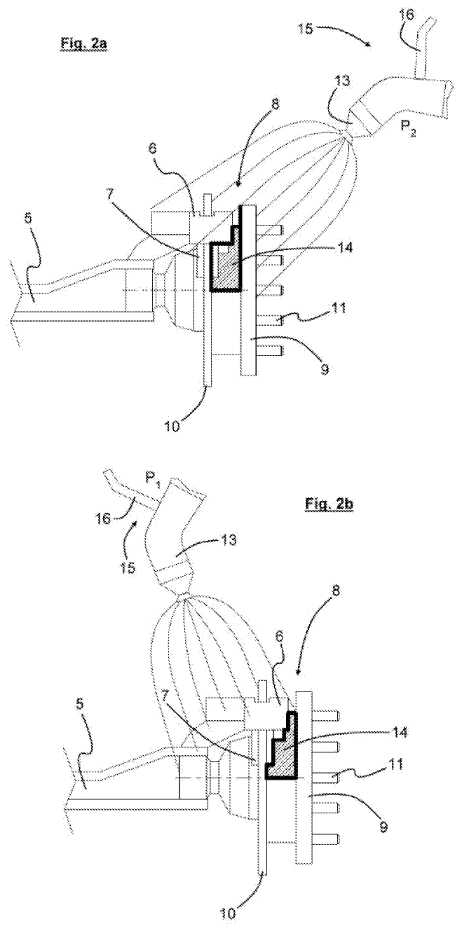

Regardless of the various possibilities of movement of the robot arm 12, there are construction-dependent shadow regions on the workpiece which are inaccessible for spray painting using the application device 13. An example of such a shadow region 14 is illustrated in FIGS. 2a and 2b, which is located substantially between the brake caliper 6 and the wheel mount 9. A uniform spray painting by the application device 13 cannot take place either from the position P₂ in FIG. 2a or from the position P₁.

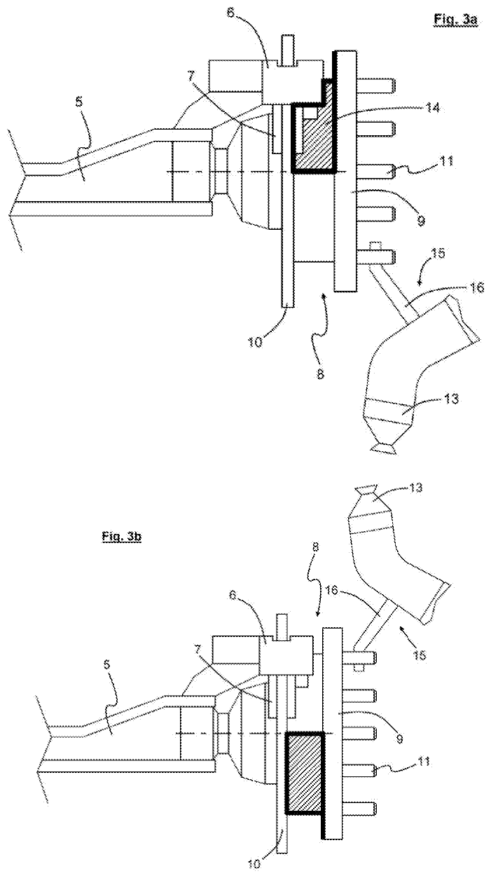

In order to produce a complete and uniform spray painting, the device according to the invention has an actuator 15, which in the illustrated embodiments has a contact device configured as a hook 16 and which is fastened on the application device 13. One of the wheel bolts 11 can be engaged behind by means of this hook 16 and the wheel suspension 8 can be rotated together with the wheel mount 9 and the brake disk 10 by approximately 180°, so that the region 14 (FIG. 3a) shaded by the brake caliper 6 is rotated to the opposite side (FIG. 3b). The application device 13 can be aligned again in this position and spray paint the previously shaded and inaccessible subregions of the workpiece. The intermediate space between two wheel bolts 11 is detected and controlled by an optical device (not shown).

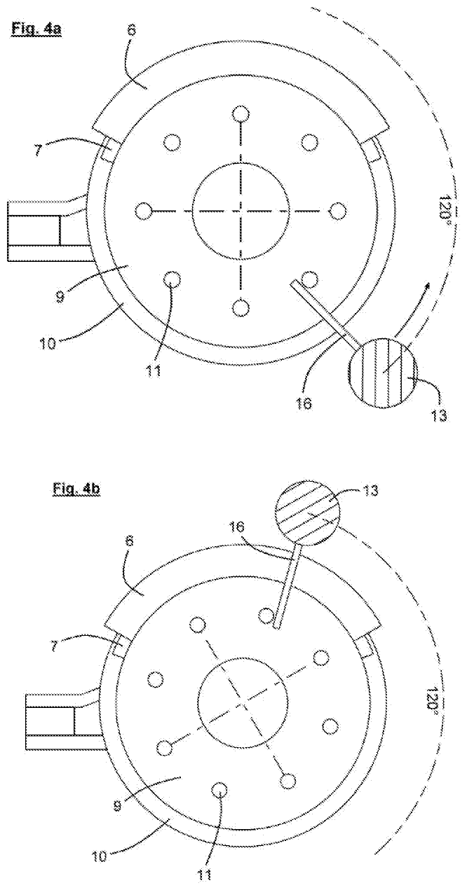

FIGS. 4a, 4b show the detail views of FIGS. 3a and 3b in a view parallel to the longitudinal axis A of the motor vehicle axle 2. It can clearly be seen here that the relatively large region, which is shaded by the brake caliper 6, is rotated out of the shaded region 14 by a rotation of the wheel mount 9 by approximately 120°, so that a complete spray painting can subsequently take place.

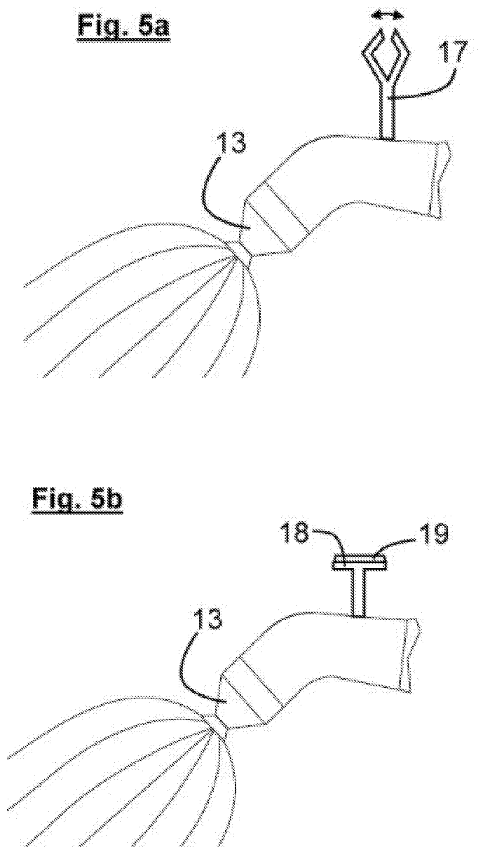

An alternative contact device of the actuator 15 is illustrated in FIG. 5a in the form of a gripper 17, which can engage a part of the wheel suspension 8 for rotating said wheel suspension, for example, the brake disk 10. In contrast, FIG. 5b shows an embodiment having a contact surface 18 which has frontal elastic material 19 in order to provide a frictional contact for rotating the wheel suspension 8.

The figures show an embodiment variant in which the contact device of the actuator 15 is arranged directly on the application device 13, so that the spray painting must be interrupted for rotating or displacing the movable component. Alternatively, the contact device can also be arranged on a separate robot arm, so that a continuous spray painting is possible.

While specific embodiments of the invention have been shown and described in detail to illustrate the application of the principles of the invention, it will be understood that the invention may be embodied otherwise without departing from such principles.

### LIST OF REFERENCE CHARACTERS

1 paint shop
2 motor vehicle axle
3 transport device
4 transport direction
5 axle body
6 brake caliper
7 brake linings
8 wheel suspension
9 wheel mount
10 brake disk
11 wheel bolts
12 robot arm
13 application device
14 shaded region
15 actuator
16 hook
17 gripper
18 contact surface
19 elastic material
A longitudinal axis
Pₙ positions

What is claimed is:

1. A method for spray painting a workpiece by means of an application device, the method comprising the steps of:
providing the workpiece that has at least two components that are movable relative to each other, which are at least sectionally arranged or meshing with each other so that, dependent on the relative position of the components, at least a subregion of one of the components is mounted so as to be a shaded region which is blocked such that the subregion for spray painting is inaccessible by the application device; and
moving one of the components during spray painting by means of an actuator such that the subregion of the component is displaced such that the subregion is no longer a shaed region and is accessible for spray painting by the application device.

2. The method according to claim 1, wherein the components are rotatable relative to each other and at least one of the components is rotated by the actuator.

3. The method according to claim 2, wherein the provided workpiece is a motor vehicle axle, which comprises:
an axle body;
at least one brake caliper; and
a wheel suspension having a brake disk and a wheel mount having a plurality of wheel bolts and/or a plurality of wheel bolt receptacles, wherein the wheel suspension is rotatable relative to the axle body and the brake caliper and subregions of the wheel mount and/or the brake disk, form the subregion that is shaded depending upon an angular position of the brake caliper.

4. The method according to claim 2, wherein the movable component is rotatable on both sides by means of the actuator.

5. The method according to claim 2, wherein the actuator has a contact device by means of which a releasable connection is made to the rotatable or displaceable component of the workpiece.

6. The method according to claim 2, wherein the rotatable component is rotated by the actuator by at least 30°.

7. The method according to claim 2, further comprising the steps of:
spray painting a part of the workpiece using the application device;
interrupting the spray painting;
rotating or displacing the component having at least one shaded subregion, so that the rotated or displaced subregion is accessible for spray painting by the application device;
spray painting of the previously shaded subregion; and
repeating the steps of spray painting a part, interrupting, rotating or displacing and spray painting of the previously shaded subregion.

8. The method according to claim 2, further comprising the steps of:
spray painting the workpiece using the application device; and
simultaneously rotating or displacing the component having at least one shaded subregion until the workpiece is completely spray painted.

9. A device for spray painting a workpiece, the device comprising:
an application device, wherein the workpiece has at least two components that are movable relative to each other, which are at least sectionally arranged relative to one another are meshing with each other so that, dependent on the relative position of the components, at least a subregion of one of the components is shaded such that the subregion is inaccessible for spray painting by the application device; and
an actuator, which allows a movement of the component during the spray painting, so that the shaded subregion of the component is displaceable such that the subregion is accessible for spray painting by the application device.

10. The device according to claim 9, wherein the components are rotatable relative to each other and that at least one of the components is rotatable by the actuator.

11. The device according to claim 10, wherein the workpiece is a motor vehicle axle, which comprises:
an axle body; and
at least one brake caliper; and
a wheel suspension having a brake disk and a wheel mount having a plurality of wheel bolts and/or a plurality of wheel bolt receptacles, wherein the wheel suspension is rotatable relative to the axle body and the brake caliper and subregions of the wheel suspension, in particular subregions of the wheel mount and/or the brake disk, are shaded dependent on the angular position of the brake caliper.

12. The device according to claim 10, wherein the actuator has a contact device by means of which a releasable connection can be made to the rotatable or displaceable component of the workpiece.

13. The device according to claim 12, wherein the contact device comprises a finger or a hook which engages behind a wheel bolt when rotating the wheel suspension or is insertable into a wheel bolt receptacle.

14. The device according to claim 12, wherein the contact device comprises a gripper, by means of which components of the workpiece can be gripped, so that the components are rotatable and/or displaceable.

15. The device according to claim 12, wherein the contact device has a contact surface which allows a frictional contact on the component for the rotation or displacement of the component.

16. The device according to 12, wherein the actuator is arranged directly on the application device or on a separate robot arm.
